(19) United States
(12) Patent Application Publication
(10) Pub. No.: US 2002/0186376 A1
(43) Pub. Date: Dec. 12, 2002

(54) Expandable closed chamber etalon with contact bonded optical components

(76) Inventor: David C. Brown, Northborough, MA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/875,667

(22) Filed: Jun. 6, 2001

(51) Int. Cl. G01B 9/02

(52) U.S. Cl. 356/454; 356/519

(57) ABSTRACT

An expandable sealed chamber and method for contact bonding optical components, suitable for electronic and optical applications such as a closed core tunable etalon. There is a spring bellows tube core with open end collars where the collar spacing is controlled by external piezo elements. Opposing tophat components are contact bonded to the collars so as to define an airgap within the chamber. The collars are fabricated of material having a coefficient of thermal expansion closely matched to that of the tophat components, and the collar end planes are prepared with a sputtered deposition layer of the same material as the tophats and then milled to an optically smooth finish for contact bonding.

### BACKGROUND OF THE INVENTION

1. Technical Field of the Invention

This invention relates to an expandable closed chamber with contact bonded components for optical and electronic applications, and in particular to a piezo element controlled expandable chamber to which optical components made of different materials are contact bonded.

2. Background Art

The most precise method known for attaching two or more parts to each other is the method known as “optical contacting” or contact bonding. This method consists of first grinding and polishing of the two surfaces to be attached, to identical mating positive and negative contours, so that the parts touch each other intimately across the entire contact area. Compression is then applied to push them together until all of the air between them is entirely squeezed out. If the parts are of the same material, then the interface between them disappears entirely, and they become essentially one part. The most common geometry contacted is the flat surface, but other surface shapes, such as spheres, and, in fact, any shape with an axis of symmetry, can be optically contacted if correctly made. Once the contact is made, then the parts will “stick” together indefinitely with a force which is at least equal to atmospheric pressure times the area in contact, plus the Van der Waals force.

The term “optical” in the phrase “optical contact” is the result of the initial discovery and application of the technique to optical parts, but in fact many other parts, such as metal gauge blocks, are regularly contact bonded for obvious benefits.

On the other hand, if the parts do not have the same coefficient of thermal expansion, then small changes in temperature will cause unequal distortion of the surfaces of the parts, and separation will begin to occur when the local shapes of the contact area cause gaps, or latent gaps, of more than several angstrom units, depending on the elastic moduli of the materials in question, since the Van der Waals radius is a few angstrom units. Once a gap of a size approaching that of oxygen or nitrogen molecules appears, capillary forces drive air molecules into the gap, wedging it progressively open until all contact is lost. For this reason, it is usual to make both sides of an optical contact of the same material.

However, it is often the case that optical or other precision parts must be attached to other components made of other materials with high precision. Such an example is a tunable Fabry-Perot etalon, in which the two optical end parts must be attached to an adjustable spacer. An etalon is a type of interferometer which is used to measure or select spectral regions of small size in the presence of light of other wavelengths. An etalon is constructed of two or many layers of materials of differing index of refraction arranged in a stack whose important property is that in the small spectral region of interest all, or almost all, the light energy experiences constructive interference. In the embodiment germane to this discussion, one of the layers is the thin layer of air sandwiched between the distal ends of the “top hat” parts, those ends themselves each layered with a multiplicity of layers of these different refractive index materials.

The purpose of the air layer is to provide the device with one layer whose thickness is adjustable, because in this way any single one of the many small spectral regions within the free spectral range of the device can be selected at random, simply by adjusting the thickness of this single layer by means of the piezoelectric actuator. This process is called “tuning”, and so this kind of etalon is called a “tunable” etalon.

The constructively interfered energy escapes the device by either reflection or transmission, while the rest of the energy escapes by the complimentary process. The reason that etalons are important is that compared with, say, colored glass filters, which select the desired spectral region by transmitting it, the etalon does not absorb a significant amount of the undesired energy. This permits, for example, the arrangement of several etalons in series, each of which reflects out of the beam a desired portion of the spectrum while passing all the rest of the spectrum, parts of which can then be selected by other etalons or used for other purposes.

In the prior art, the optical parts were attached to the spacer by means of an adhesive layer. For example, referring to prior art patent, Jager's BG2174494, published Nov. 5, 1986, its FIG. 1 illustrates a piezoelectric core material 2.3, which is suggested to be invar for its thermal expansion characteristics, to which tophat glass plates 2.1 and 2.2 are bonded to form an airgap tunable etalon. Although thin and as uniform as possible, an adhesive layer at such a junction responds to temperature change in a sufficiently non-uniform manner as to cause tilting of the optical parts, which makes many of such assemblies unsuitable for use.

In some cases, materials of dissimilar thermal characteristics are used, such as a piezoelectric stack of ceramic rings to which quartz washers are bonded and to which quartz tophats forming the etalon airgap are then bonded. The differential thermal expansion between the piezo element and the quartz washers must be absorbed in the very thin adhesive layers between these components. Since this thin glue layer is highly stressed as a result of these effects, it must consist of a flexible material or it will become delaminated from one or both of the mating surfaces. The flexibility of this layer, in turn, reduces the stiffness of the structure, imposing limits on the precision to which the subassembly can be finished both in length and in terms of parallelism of the opposed faces of the tophat components.

There are also the electrical wires that are attached to the piezo elements during fabrication of this component, generally using special techniques at the piezo supplier's factory, before the final protective coating is applied to strain-relieve the wires. As a result, the wire leads are present during subsequent fabrication steps of the etalon assembly, and may interfere with that processing. In particular, the grinding swarf created from the contact area preparations accumulates between the wire and the body of the piezo where the wire is wrapped and taped out of the way of the ends, so that many wrap-unwrap cycles are required during cleaning, causing a significant number of wires to break off.

Because of the specialized nature of the soldering process required to replace these wires, the salvage costs are uneconomical, and so these units together with the value invested in their processing, is lost. Finally the thick, stiff polymer coating on the inner and outer surfaces of the piezo annulus required to protect current designs from mechanical and environmental damage imposes stress on the piezo element itself, and also on the joint between the ceramic and the washer, which contribute to the undesirable motions, instability, and to the delamination of the washer-piezo joint. Delaminated units can not be economically reclaimed.

The prior art problems have prompted the development of a relatively new design approach to the piezo driver, using a monolithic, cylindrical, open spring core assembly, into which are configured lengthwise slots to accommodate lengthwise oriented piezo posts. The spring core assembly holds the piezo posts under pre-loaded lengthwise compression about the circumference of the open spring core assembly annulus. The use of a set of small, piezo post elements matched to each other in thermal and electrical characteristics, combined with the ability to control the production of the raw ceramic and the use of a pre-loaded core design, provides significant improvements in linearity, tilt, and stability of the finished etalon. However, an initial short coming implicit in this approach is how to accomplish the bonding of the existing prior art “top hat” components to the new driver structure so as to achieve the obvious economy of using existing optical parts, while avoiding the shortcomings of the thermally and structurally defective quartz washer—ceramic ring bond of some prior art designs. An additional problem is the exposure of the interior airgap region of the etalon both during and after the fabrication process, through the openings in the spring core. A closed chamber design with suitably bonded optical components would be an important improvement.

### SUMMARY OF THE INVENTION

My invention, most simply stated, is to replace the open frame spring core of the later described etalon design with a contracting spring bellows with end collars actuated for expansion by external piezo elements, which provides for a closed and hermetically sealed etalon design. And further, in these and other designs, to replace the adhesive layer of the prior art bonds used to bond an optical component of one material to a chamber core component of another material, using a uniformly thin layer of the optical material deposited on the non-optical component as a contact surface.

The bonding method is carried out by the process of first, using materials of substantially equal thermal expansion characteristics for both the two components being joined, such as quartz and an INVAR metal; then sputtering, or otherwise depositing, a thin layer of the material of the second component, such as quartz, onto the mating surface of the first component, such as a collar on the expandable chamber. The first component in this case is preferably made of a metal, such as one of the Invars, formulated to have the same coefficient of expansion as the second component material, quartz, to be contacted.

The thin interfacial layer applied to the contacting surface of the first component is then ground and polished to the required flatness and finish required to permit optical contact bonding to take place.

Since the worked surface is the same material as that of the optical component, the very same process, materials, and techniques used for the optical part are used for the non-optical part, assuring the same degree of flatness and surface quality. Once contact is made, since the materials on both sides of the contact zone are the same, the contact is maintained in spite of substantial temperature variation.

Parts to be bonded in this way must be very hard, flat, polished, and without sharp edges or corners which might throw up microscopic burrs when the two plates are brought into contact. Such burrs represent localized departures from flatness and polish which would interfere with the formation of the bond. Also, unless the two bonded materials have essentially the same coefficient of thermal expansion, the thermally induced strain between the parts is likely to break the bond if the temperature changes.

To put the dimensions of this optical contacting process into quantitative terms, it is generally considered that materials to be bonded must be at least as hard as very hard steel, be flat to at least 1/50 wave of visible light, and have a polish (flow of the surface) whose imperfections are on the order of the size of the molecules of the parent material.

Of course, quartz is a commonly used material for optical components of etalons. However, it will be readily apparent that this invention applies equally for optical materials other than quartz, requiring only that a supply of the material be available for the sputtering chamber, and that a metal alloy of the correct coefficient of expansion is available. These metals, such as the Kovars, have been developed in large variety for the purpose of glass to metal seals, because glasses, in general, have lower coefficients than do metals. However, new alloys are easily developed as required to match new optical materials as they come into use. It may well be that future optical materials, or precision materials, will be developed whose coefficient of expansion is larger than most metals. In that case, matching metals will have to be developed which have larger, rather than smaller, coefficients.

Other objects and advantages of the present invention will become readily apparent to those skilled in this art from the following detailed description, wherein we have shown and described only a preferred embodiment of the invention, simply by way of illustration of the best mode contemplated by us on carrying out our invention.

### BRIEF DESCRIPTION OF THE FIGURES

FIG. 1 is an exploded, perspective view of an etalon of advanced design with a monolithic spring core top hats being attached according to a preferred embodiment method, indicating the area of quartz deposition on the end plane of the INVAR core/spring component.

FIG. 2 is an exploded perspective view of a preferred embodiment etalon core structure, utilizing the preferred embodiment top hat attachment method of FIG. 1.

### DESCRIPTION OF THE PREFERRED EMBODIMENT

The invention is susceptible of many variations. What is described below and illustrated in the figures is only a preferred embodiment.

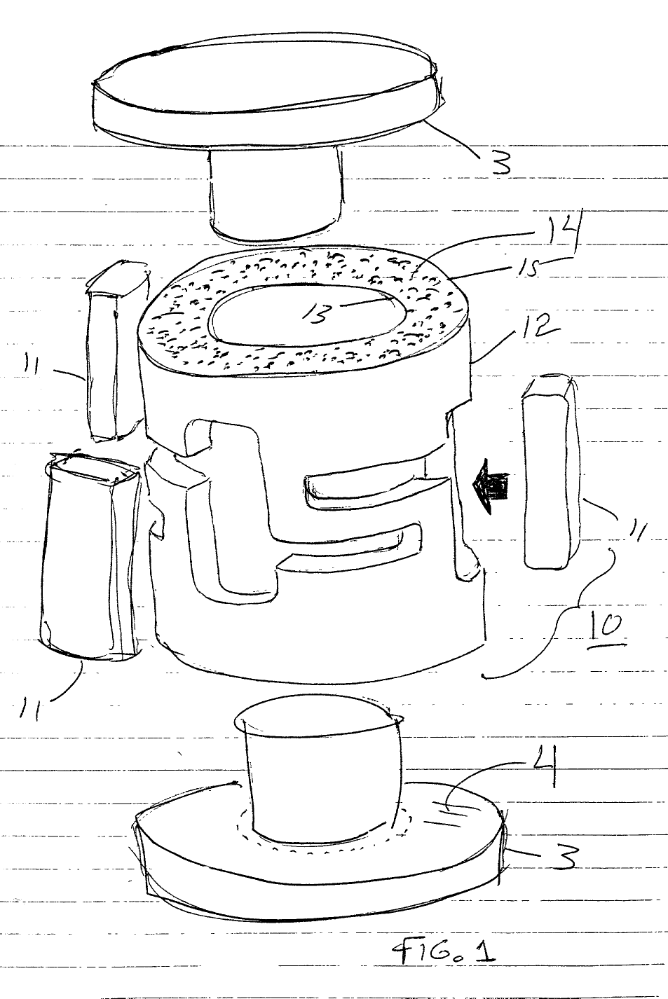

Referring to FIG. 1, there is shown an etalon with a monolithic metal core 12 that functions as the seat and pre-loading spring force for the set of circumferentially arranged elongate piezo post structures 11, holding the posts parallel to the axis and in longitudinal compression sufficient to mask perturbations in the normal length of the posts that are caused by small irregularities, imperfections or inconsistencies between posts 11. The metal core/spring component 12 also incorporates parallel end planes that must be adequately bonded to the existing design top hat 3 components to assure the necessary structural integrity and controllability required of the etalon.

In accordance with the preferred embodiment method for attachment of tophats to core structure, core/spring component 12 of the assembly is fabricated using INVAR, an alloy having properties of thermal expansion closely comparable to quartz, the material of which tophats 3 are fabricated. Of course, another materials could be chosen for the respective components, so long as their coefficients of expansion are matched.

There is then created a quartz surface on the two end planes 14 of core 11. First, the sharp inner and outer edges 13 and 15 of end planes 14 of the core are reduced to a uniformly small radius of approximately 0.010″. Sputtering techniques are then employed to deposit about a 10 micron layer of quartz on each of end planes 14, including on the rounded edges. Other forms of deposition are within the scope of the invention, as are intermediate layers and materials that improve the quality of the final finish surface for optical contact bonding. Finally, about 2 microns of the quartz layer is precision milled or polished off the rough surface to create an optically smooth finish surface on planes 14, without sharp edges, for optical bonding to respective quartz tophat 3 components. Deposition depths of more or less than 10 microns may be necessary or adequate, depending on the original surface condition, the condition of the final sputtered surface, and the milling or polishing depth required to obtain an optically smooth finish surface.

The contact surfaces of tophats 3 are prepared with a similar optically smooth finish. The device is otherwise assembled as required, with the optical bonding providing the thermally balanced interface between tophats 3 and core/spring component 12 that inhibits the distortion caused by differing thermal expansion across the joint.

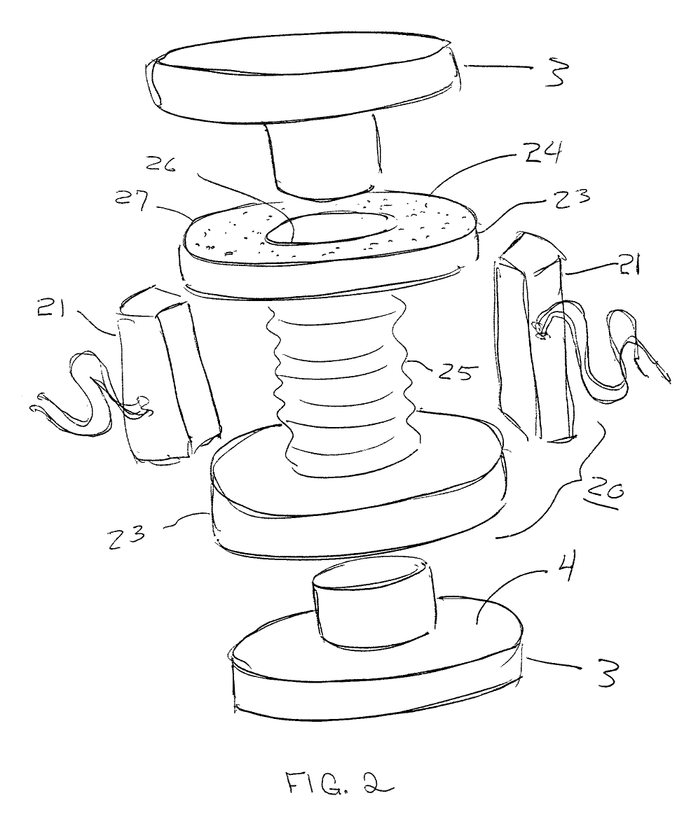

Referring to FIG. 2, there is shown a preferred embodiment etalon core structure 20; its principle elements consisting of parallel end plates 23, mechanically interconnected with a tubular spring bellows tube 25. Core structure 20 can be either a monolithic, milled structure, or an assembly of two collars attached, as by laser welding, to the tubular bellows core component. In the latter case, the bellows core tube 25 is fabricated from 0.002 inch thick Invar sheet stock 2, rolled, seam welded, and hydroformed for the convolutions. The finished tube has about a 50 Newton/micrometer spring stiffness constant, preferably about half the stiffness of the ceramic piezo posts. The required range of bellows extension length is about two microns for tuning the airgap of a tunable etalon in the 1.3 to 1.5 micron wavelength range. It will be readily appreciated that the design is adaptable to other wavelengths.

The bellows tube structure can be formed by other means, such as by stacking and seam welding a series of Belville™ washers. (No claim being made to the trademark.)

The bellows spring tube 25 is placed in tension by the insertion of three (only two shown in FIG. 2 for clarity) circumferentially arranged elongate piezo posts 21, into the space between the two endplates 23, external to bellows tube 25. The posts 21 are oriented parallel to the axis of core structure 20, normal to the plane of end plates 23, and held under longitudinal compression by end plates 23 from the tension of bellows tube 25. The piezo element could equally well be a single, circular element, such as a stack of ceramic rings.

It will be appreciated that the spring constant and working range of the tension spring action of the bellows core tube must be sufficient at all operating temperatures and chamber core lengths to maintain suitable compression on the piezo element, which acts only to expand, not contract, the distance between the optical contact surfaces of end plates 23 and hence the airgap of the etalon.

Benefits of the spring bellows etalon core structure 20 embodiment of an etalon core are several fold. As in the prior embodiment, the bellows and end plate core accommodates top hat 3 components of existing sizes used in other designs. The bellows component need not be made of material of the same thermal characteristics as the endplates or tophats, so long as its seal is maintained and its ability to hold endplates 23 in tension against piezo posts 21 is not adversely affected by variations in temperature. The finished structure of the etalon core tube and endplates contact bonded to the top and bottom tophats, isolates the piezo post fabrication process, and the device installation and operating environment from the hermetically sealed interior of the etalon.

As in the prior embodiment, the parallel end plates 23 must still be adequately bonded, preferably contact bonded in the manner described, to the top hat 3 components to assure the necessary structural integrity and controllability required of the etalon. In the preferred embodiment, end plates 23 are fabricated using INVAR, an alloy having properties of thermal expansion closely comparable to quartz, the material of which tophats 3 are fabricated. Of course, another materials could be chosen for these respective components, so long as their coefficients of expansion are matched.

There is then created a quartz surface on the two end planes 24 of end plates 23 by first reducing the sharp inner and outer edges 26 and 27 to a uniformly small radius of approximately 0.010 inches. Sputtering techniques or other methods of deposition are then employed to deposit about a 10 micron layer of quartz on each of end planes 14, including the rounded edges. Finally, about 2 microns of the quartz layer are precision milled or polished off the rough surface to create an optically smooth finish surface on end planes 24, without sharp edges, for bonding to respective tophat 3 components. As previously stated, deposition depths of more or less than 10 microns may be necessary or adequate, and an intermediate layer may be useful, depending on the original surface material and condition, the bonding surface material and condition after deposition, and the milling or polishing depth required to obtain an optically smooth finish surface.

Again, the corresponding contact surfaces of quartz tophats 3 are prepared with a similar optically smooth finish, preferably by the same milling or polishing technique. The device is otherwise assembled as required, with the optical contact bonding providing the thermally balanced interface between tophats 3 and end plates 23. The distance between the tophats is a function of the state of excitation of piezo posts 21, thus controlling the airgap between the optical surfaces within the sealed chamber, without the distortion caused by differing thermal expansion across the end plane to tophat joint.

Other embodiments within the scope of the invention will be apparent to those skilled in the art. For example, there is an expandable chamber for optical and electronic applications, consisting of a flexible chamber wall and at least one external piezo control element configured to cause single axis expansion of the chamber when actuated. The expandable chamber may have open end surface such as an open end collar, suitable for contact bonding. There may be an optical component already contact bonded in the manner described above to the open end surface. The open end surface may be made of the same material as the optical component or it may not.

Where it is not, the open end surface may be fabricated of a non-optical or dissimilar material of substantially the same thermal expansion characteristics as the optical material used in the optical component, and the open end surface will have a thin layer of optical material deposited on it, by sputtering or other suitable means of deposition, and milled as by polishing or other means, to a precision finish suitable for contact bonding of optical components.

As another example, there is an expandable closed chamber for optical applications consisting of a flexible chamber wall such as a bellows tube or other accordion-like, foldable or collapsible wall structure. There is an optical component, and at least one external piezo element configured to cause lengthwise expansion of the chamber when the piezo elements are actuated. The chamber has an open end surface which may be fabricated of a non-optical material of substantially the same thermal expansion characteristics as the optical material of the optical component, upon which a thin layer of the optical material has been deposited and then milled or polished by suitable means known to those in the art to a precision finish. The optical component is contact bonded to open end surface, enabled by the precision finish and a mating like finish on the optical component.

As yet another example, there is an expandable closed chamber consisting of an expandable spring bellows tube, and at least one piezo element, where the bellows tube is expandable lengthwise by actuation of the piezo elements. The bellows tube may terminate in an open end collar, where the collar is configured with a precision surface for contact bonding with an optical component. The optical component will have a mating precision surface, so it can be contact bonded to the collar.

The optical component and the collar may be fabricated of the same material, or of different materials having substantially the same thermal expansion characteristics as described above. Where the materials are different, one or the other of the collar and optical component will have a thin layer of the opposite material deposited on its own precision surface and milled to a precision finish, to facilitate the contact bonding.

As described above, the collar may be made of INVAR, and the optical component of quartz; quartz material being deposited on the collar for the contact bonding. The quartz may have been deposited by sputtering or other of several possible deposition means as will be apparent to those skilled in the art.

The one piezo element may alternatively be three piezo post elements or more, arranged with equal spacing around the bellows tube between the collars. The optical components may be etalon tophats or end components that form the optical surfaces and airgap, each having a mating precision surface for being contact bonded to a respective collar.

As yet still another example of the invention, there is a tunable etalon consisting of a spring bellows core tube with open end collars at each end, where the end collars have precision end surfaces for contact bonding. There are at least three external piezo elements equally spaced around the tube between the collars so as to place the bellows core tube in tension and expand the tube lengthwise when actuated, and a pair of etalon tophat components with mating precision end surfaces for contact bonding to the respective said end collars.

As in other embodiments, the collars and tophat components may be fabricated of different materials having the same coefficient of thermal expansion, where the precision end surfaces of the collars are configured with a thin layer of the same material as the tophat components and suitably finished so that the tophat components can be bonded to the collars. The collars may be of INVAR, the tophats of quartz, and the thin layer of quartz have been deposited by sputtering.

There is also a method within the scope of the invention, for fabricating an expandable chamber for contact bonding to at least one optical component made of an optical material, consisting of the steps of fabricating from a non-optical or other dissimilar material an open end collar for the chamber, where the non-optical material has substantially the same thermal characteristic as the optical material, preparing the open end collar with a precision mating surface with rounded inner and outer edges, depositing on the precision mating surface a thin layer of optical material, then milling, polishing or otherwise finishing the thin layer to a precision finish suitable for contact bonding with the optical component.

There is a further method, this one for fabricating a closed chamber airgap etalon having at least one optical tophat fabricated of an optical material and piezo gap control elements, consisting of the steps of using a spring bellows tube core, fabricating an expandable etalon tube core with at least one open end collar, preparing the open end collar with a precision surface with rounded inner and outer edges, depositing on the precision surface a thin layer of optical material, milling or otherwise preparing the thin layer as a precision finish, contact bonding the optical tophat to the collar, disposing piezo control elements around the tube core against the base of the collar so as to hold the spring bellows tube in tension and expand the tube when actuated.

For this and other methods, the one optical tophat may be two tophats; the one open end collar may be an open end collar at each end of the tube core, and the steps of preparing, depositing, milling, and contact bonding will apply to both ends of the tube core.

Other embodiments, examples, goals and objectives of the invention within the scope of the claims that follow will be readily apparent to those skilled in the art from the description and figures provided.

I claim:

1. An expandable chamber comprising a flexible chamber wall and at least one external piezo element configured to cause single axis expansion of said chamber when actuated.

2. An expandable chamber according to claim 1, said chamber having an open end surface suitable for contact bonding.

3. An expandable chamber according to claim 2, further comprising an optical component contact bonded to said open end surface.

4. An expandable chamber according to claim 3, said open end surface comprising the same material as said optical component and having a precision finish thereon suitable for contact bonding.

5. An expandable closed chamber for optical applications comprising a flexible chamber wall, an optical component, and at least one external piezo element configured to cause lengthwise expansion of said chamber when actuated, said chamber having an open end surface suitable for contact bonding, said open end surface comprising the same material as said optical component, said optical component being contact bonded to said open end surface.

6. An expandable chamber according to claim 3, said open end surface being fabricated of a non-optical material of substantially same thermal expansion characteristics as the optical material of said optical component, said open end surface having a thin layer of said optical material deposited thereon and milled to a precision finish.

7. An expandable closed chamber for optical applications comprising a flexible chamber wall, an optical component, and at least one external piezo element configured to cause lengthwise expansion of said chamber when actuated, said chamber having an open end surface, said open end surface being fabricated of a non-optical material of substantially same thermal expansion characteristics as the optical material of said optical component, and having a thin layer of said optical material deposited thereon and milled to a precision finish, said optical component being contact bonded to said open end surface.

8. An expandable closed chamber comprising
an expandable spring bellows tube, and
at least one piezo element, said bellows tube being expandable lengthwise by actuation thereof.

9. An expandable chamber according to claim 8, at least one end of said bellows tube terminating in an open end collar, said collar configured with a precision surface for contact bonding with an optical component.

10. An expandable chamber according to claim 9, further comprising a said optical component with a mating said precision surface, said optical component being contact bonded to said collar.

11. An expandable chamber according to claim 10, said optical component and said collar being fabricated of the same material.

12. An expandable chamber according to claim 10, said collar and said optical component being fabricated of different materials having substantially the same thermal expansion characteristics.

13. An expandable chamber according to claim 12, one of said collar and said optical component having like material of the other of said collar and said optical component deposited on its own said precision surface and milled to a precision finish.

14. An expandable chamber according to claim 13, said one of said collar and said optical component being said collar, said collar being fabricated of INVAR, said other of said collar and said optical component being said optical component, said optical component being fabricated of quartz, said like material having been deposited on said precision surface of said collar being quartz.

15. An expandable chamber according to claim 14, said like material having been deposited by sputtering.

16. An expandable chamber according to claim 9, each end of said bellows tube terminating in a said open end collar, said at least one piezo element being at least three piezo post elements arranged with equal spacing about said bellows tube between said collars.

17. An expandable chamber according to claim 16, said optical components being etalon tophats with mating said precision surfaces, each said tophat being contact bonded to a respective said collar.

18. A tunable etalon comprising
a spring bellows core tube with open end collars at each end, said end collars having precision end surfaces for contact bonding,
at least three external piezo elements equally spaced around said tube between said collars so as to place said bellows core tube in tension and expand said tube lengthwise when actuated, and
a pair of tophat components with mating said precision end surfaces, said tophat being contact bonded to respective said end collars.

19. A tunable etalon according to claim 18, said collars and said tophat components being fabricated of different materials having the same coefficient of thermal expansion, said precision end surfaces of said collars being configured with a thin layer of the same material as said tophat components, said tophat components contact bonded to respective said precision end surfaces of said collars.

20. A tunable etalon according to claim 19, said collars being fabricated of INVAR, tophat being fabricated of quartz, said thin layer having been deposited thereon by sputtering

21. A method for fabricating an expandable chamber for contact bonding to at least one optical component made of an optical material comprising the steps of,
fabricating from a non-optical material an open end collar for said chamber, said non-optical material having substantially the same thermal characteristic as said optical material,
preparing said open end collar with a precision mating surface with rounded inner and outer edges,
depositing on said precision mating surface a thin layer of said optical material,
milling said thin layer to a precision finish suitable for contact bonding with said optical component.

22. A method for fabricating an expandable chamber according to claim 21, said non-optical material being INVAR, said optical material being quartz.

23. A method for fabricating an expandable chamber according to claim 22, said depositing being sputtering.

24. A method for fabricating a closed chamber airgap etalon having at least one optical tophat fabricated of an optical material and piezo gap control elements comprising the steps of:
using a spring bellows tube core,
fabricating an expandable etalon tube core with at least one open end collar,
preparing said open end collar with a precision surface with rounded inner and outer edges,
depositing on said precision surface a thin layer of said optical material,
milling said thin layer to a precision finish,
contact bonding said optical tophat to said collar,
disposing said piezo control elements around said tube core against said collar so as to hold said spring bellows tube in tension and expand said spring bellows tube core when actuated.

25. A method for fabricating a closed chamber airgap etalon according to claim 24, said at least one optical tophat being two tophats, said at least one open end collar being an open end collar at each end of said tube core, said steps of preparing, depositing, milling, and contact bonding applying to both ends of said tube core.
